(19) United States
(12) Patent Application Publication
(10) Pub. No.: US 2024/0046348 A1
(43) Pub. Date: Feb. 8, 2024

(54) SYSTEMS AND METHODS FOR CREDIT OFFERS, PRIVATE LABEL PREQUALIFICATION FOR LENDERS, AND ACCOUNT OPENING

(71) Applicant: CreditSnap, Inc., San Antonio, TX (US)

(72) Inventors: Deepak Polamarasetty, San Antonio, TX (US); Sreeramulu Jadapolu, San Antonio, TX (US); Srinivas Thumati, San Antonio, TX (US)

(21) Appl. No.: 18/235,207

(22) Filed: Aug. 17, 2023

Related U.S. Application Data
(60) Provisional application No. 63/353,206, filed on Jun. 17, 2022.

(51) Int. Cl. G06Q 40/03

(52) U.S. Cl. CPC G06Q 40/03

(57) ABSTRACT

A system for providing credit offers, private label prequalification for lenders, and account opening is disclosed, including at least one user computing device in operable connection with a user network. An application server is in operable communication with the user network to host an application program for providing credit offers, private label prequalification for one or more lenders, and an account opening process. The application program includes a user interface module for providing access to the application program via the at least one user computing device. A processor and a non-transitory computer readable memory stores instructions that, when executed by the processor upon a user selection, cause the device to provide end-to-end account opening and provide the deployment of a lending journey.

### CROSS-REFERENCE TO RELATED APPLICATIONS

The present application claims priority to U.S. Provisional Application No. 63/394,432 filed Jun. 17, 2022, titled “SYSTEMS AND METHODS FOR CREDIT OFFERS, PRIVATE LABEL PREQUALIFICATION FOR LENDERS, AND ACCOUNT OPENING” which is hereby incorporated by reference in its entirety.

### TECHNICAL FIELD

The embodiments disclosed herein generally relate to computer implemented systems and methods for determining fully qualified credit offers for multiple lenders, unified platforms with fully private label prequalification for multiple lenders, and account opening processes in a single session.

### BACKGROUND

As a first issue, technology automation exists that matches a single borrower to a single lender. This technology is often recycled and will be repeated or manually applied for iterative matching with each incremental lender. Occasionally, in order to save time, money, and effort, an underwriter will attempt to guess or otherwise estimate the most likely lenders (e.g., two or three) that may be willing to work with a borrower. In such instances, the underwriter may only run those lenders' criteria. This may result in the introduction or inclusion of human bias and inefficient back and forth discussions with sub-optimal lenders in early stages. As such, the result may be a reduced or eliminated ability to timely complete a loan for the borrower. Systems and methods are desirable that significantly reduce human capital expenditure in the form of time and effort. The removal and/or significant reduction of lender selection bias and significant improvement of loan processing times is also desirable.

As a second issue, SaaS technology providers with pre-qualification capabilities could benefit from propping up a new application for private label brands. While propping up individual lending digital experiences, including coding for credit rules and coding for integration to downstream systems is currently fairly common, it may take an extensive amount of time (e.g., three or more months). Systems and methods with integrated and fully configurable digital experiences, including self-service credit decisioning engines, may operate to activate new private label experience within the span of a week or even less.

As a third issue, the process for opening a deposit account currently involves filling out a number of forms, physically traveling to a branch for identity verification, confirming eSignatures via email or physically executing signatures at branch, physically giving a check to a representative at a branch for an initial deposit, and waiting several days and weeks for an account to be opened. As such, this process can be time consuming and inconvenient. Systems and methods that simplify and ease the entire account setup process are highly desirable. These may include fully configurable steps that allow for seamless and quick start to finish operation by end customers. 100% remote and rapid account opening (e.g., in under 15 minutes) would be beneficial. What would otherwise be a time-consuming process that requires days or weeks to perform with physical travel to a branch on multiple occasions would benefit from being performed over a computer network in under fifteen minutes. This degree of automation could be configurable across financial institutions.

As a fourth issue, the process of identifying additional product suggestions that can be highly beneficial to the applicant can be a very time consuming and a human resource intensive process. Further, to be able to consider product suggestions from different product categories can be an even more complex decisioning making process (e.g., identifying and automating deposit product suggestions and choices in the loan process or identifying and determining eligibility of loan product offers in the deposit account process). Automation of such processes delivers self service capabilities in this product recommendation and suggestion process.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a system for providing credit offers, private label prequalification for lenders, and account opening, including at least one user computing device in operable connection with a user network. An application server is in operable communication with the user network to host an application program for providing credit offers, private label prequalification for one or more lenders, and an account opening process. The application program includes a user interface module for providing access to the application program via the at least one user computing device. A processor and a non-transitory computer readable memory stores instructions that, when executed by the processor upon a user selection, cause the device to provide end-to-end account opening and provide the deployment of a lending journey.

The embodiments provide Instant matching of a single borrower to multiple lenders, activation of pre-qualified lending platforms in less than one week, and rapid deployment of account openings are highly desirable.

In one aspect, the account opening process includes a designation display for a lowest payment, a lowest rate, or an offer.

In one aspect, the lending journey is not provided with a request for a specific loan amount.

In one aspect, a prescreen process allows for the preparation of a preapproval file.

In one aspect, the preapproval file is transmitted via email using a communication module.

In one aspect, the communication module transmits mail to one or more prequalified buyers.

In one aspect, the system includes the step of a credit module applying one or more credit rules to the preapproval file.

In one aspect, a decision module is in communication with at least one or more credit bureaus for credit bureau data to allow the lender to determine whether it may issue the loan to one or more prequalified applicants.

In one aspect, a borrower, the credit bureau, a bank, and a credit union can interact with the loan to begin an underwriting process.

In one aspect, a deposit account is capable of determining if a user is a member by referencing a core system integration, create an application, determine eligibility, and generate one or more update offers.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 illustrates a block diagram of the application program and computing system, according to some embodiments;

FIG. 3 illustrates an architecture diagram, according to some embodiments;

FIG. 4 illustrates a system and credit bureau decisioning process flowchart, according to some embodiments;

FIG. 5 illustrates a process flowchart, according to some embodiments; and

FIG. 6 illustrates a deposit account flowchart, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments herein are implemented and include a number of new features. These features include relevance scoring for loan offers that indicate the percentage or odds of response from a customer. The system also provides instant end-to-end account opening ability and the display of designations on a user interface of “lowest payment,” “lowest rate,” or other offers with an intuitive layout and design. The system may provide the deployment of a lending journey without requiring a request for a specific loan amount instead informing a customer of what loan amount is possible given the lenders' specifications. This system enables the rapid deployment and activation of new accounts and others.

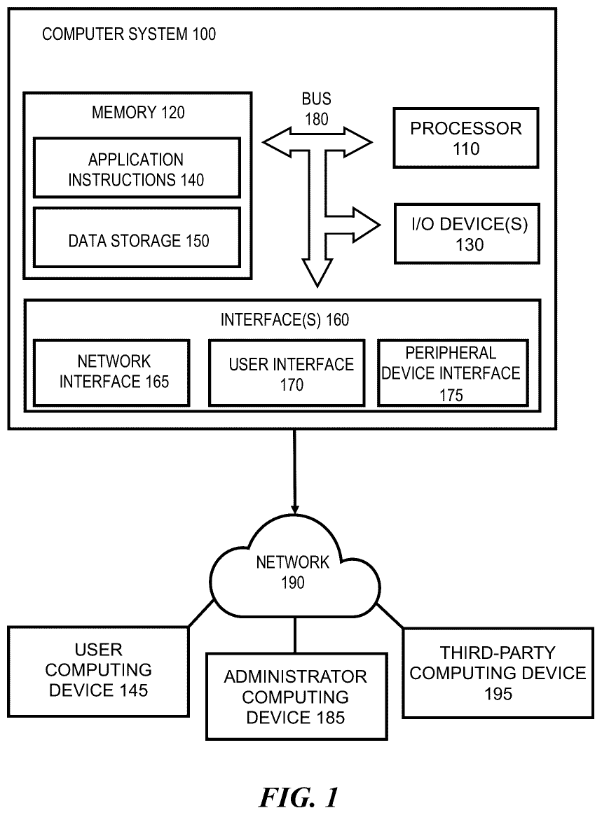

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized a user (e.g., a healthcare provider) to interact with the various functionalities of the system including to perform patient rounds, handoff patient rounding responsibility, perform biometric verification tasks, and other associated tasks and functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

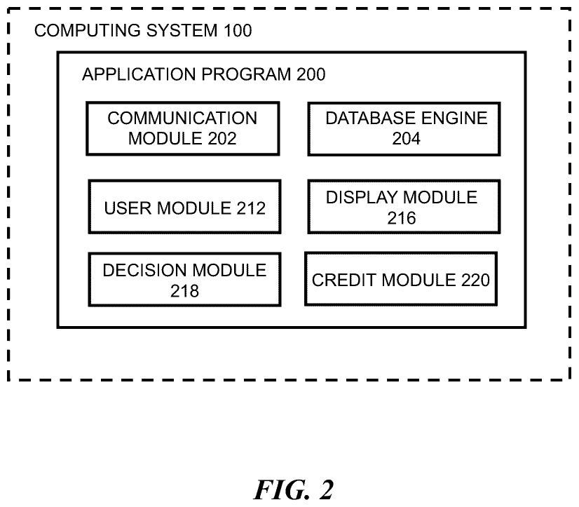

FIG. 2 illustrates an example computer architecture for the application program 200 operated via the computer system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a user module 212, a display module 216, a deposit module 218, and a credit module 220.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 302 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, the communication module 202 allows for the transmission of emails, mail, and similar communication to borrowers, lenders, banks, prequalified buyers/borrowers, etc. Communications may be automated, such as the automated transmission of preapproval offers, loan offers, etc.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

The user module 212 may store user preferences including the user account information, historical usage data, user personal information, user credit information, and the like.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 provides alerts to the user device which can be viewed and acknowledged by the user.

In some embodiments, the decision module 218 receives a plurality of user information, user credit history, collateral information, and the like, including additional information from a credit module 220 to assess user credit worthiness and provide a decision (YES/NO) if the user is granted pre-approval, automatically approved, denied, is high risk, etc.

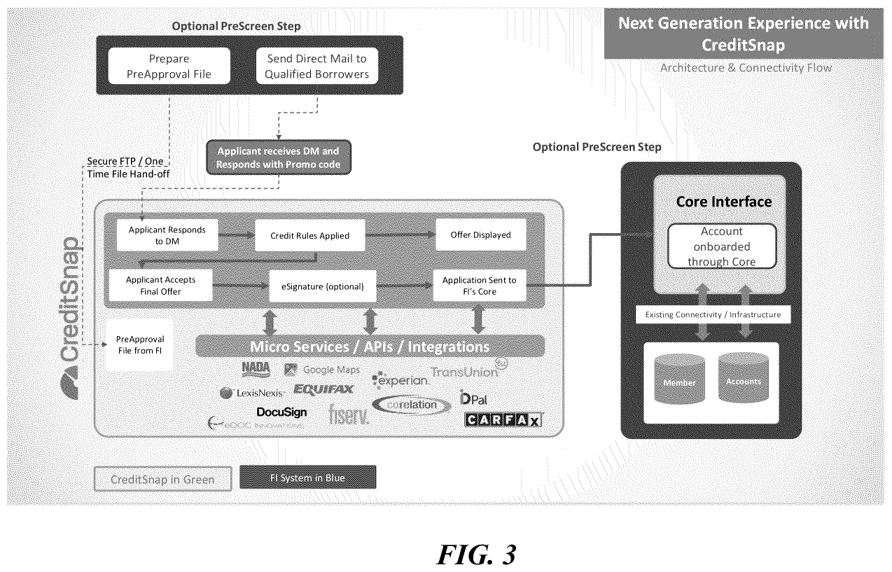

FIG. 3 illustrates an architecture diagram. As shown in the example embodiment, an optional prescreen step can be an initial step. This prescreen step can include preparing a preapproval file and/or sending direct mail to qualified buyers. Preparing a preapproval file can be then sent via secure FTP/One Time File Hand-off to the system, whereby a preapproval file from a financial institution is received. A sending direct mail to qualified buyers' step can result in an applicant receiving the direct mail and responding with a promo code, for instance by accessing the company website. This can result in credit rules being applied, displaying an offer, applicant accepting a final offer, e-signing and sending the application to the financial institution. Microservices, APIs and Integrations can all be employed to strengthen and smooth the process.

Next, an optional prescreen step can include data received from the system at a core interface of the financial institution that is operable to onboard an account, exchange data via existing connectivity/infrastructure with member and/or account databases.

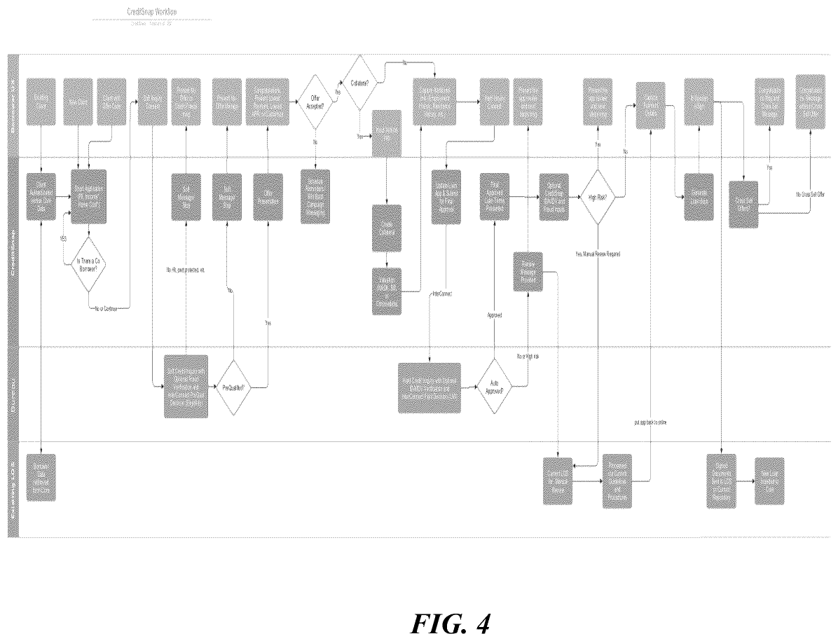

FIG. 4 illustrates a system and credit bureau decisioning process flowchart, according to some embodiments. As shown, numerous layers exist, including an existing LOS, Bureau, system, and borrower user interface.

An existing client can authenticate via core data, which core data can also be retrieved before starting an application. Otherwise, a new client or client with an offer code can start an application. The system can determine if there is a co borrower and their information. If not, or to continue, the system can run a soft inquiry consent and inquire with the bureau for option fraud verification and prequalification decision. Next a soft message to stop and presentation of no offer can occur. Otherwise, the system can check if the person is prequalified. If no, a soft message stop and no-offer message can be displayed. If yes, an offer presentation can occur with congratulations, lowest payment, lowest apr and/or customized offer. If the offer is not accepted, a win back campaign can be scheduled. If the offer is accepted, the system can determine if collateral exists.

If collateral, the user can input vehicle information, the system can create collateral, and valuation can occur before capturing additional information. Otherwise, additional information can be captured, and a hard inquiry consent can be demanded/given. The loan application can then be updated for final approval and the system can run a hard credit inquiry before determining if auto approval has occurred. If no or the person is high risk, the system can provide a review message and present the app review and next steps message and/or log current los for manual review and process according to current guidelines and procedures before capturing fulfillment details.

Otherwise, if auto approval occurred and the person was approved, the person can receive a first approved loan time which is presented before an optional system fraud inputs application occurs. The system can determine if high risk and present the app review and next steps message if so, or, if not, capture fulfillment details.

Next, loan docs can be generated and in a session the user can e-sign. Signed docs can be sent to LOS or current repository and the new loan boarded to the core, while cross sales to others can be determined. If yes, congratulations message to the user and if no, congratulations message to the user without cross sales.

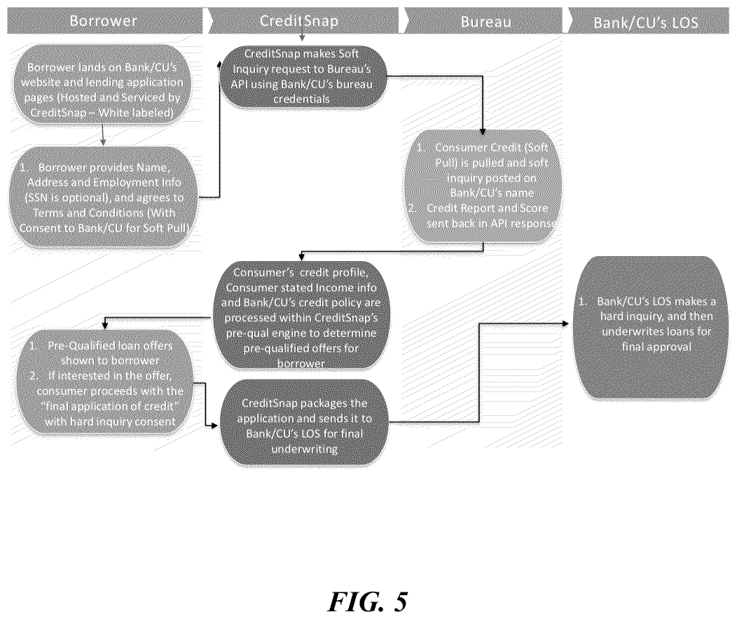

FIG. 5 illustrates a process flowchart, according to some embodiments. As shown, borrowers, the system, credit bureau(s), and banks and/or credit unions can interact with a loan for underwriting.

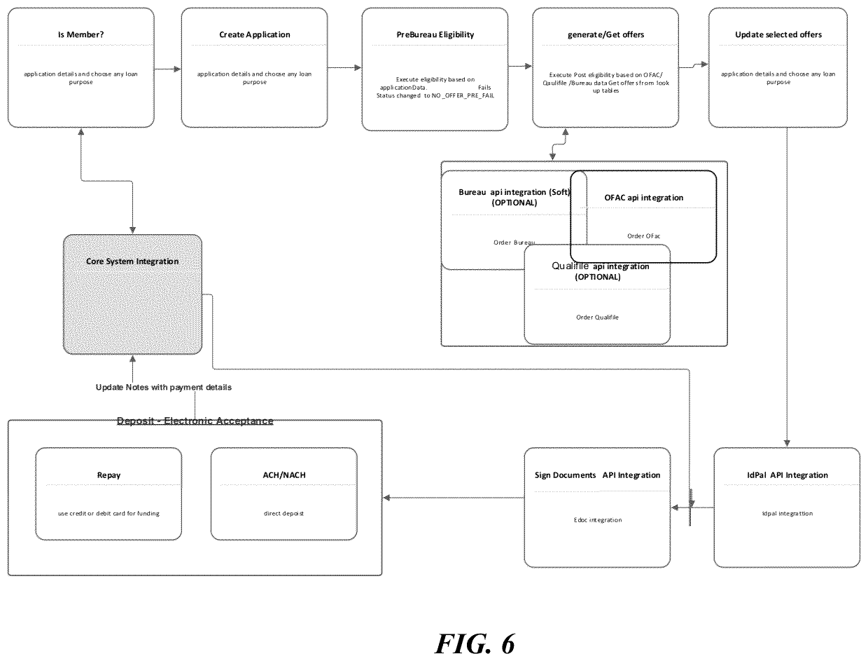

FIG. 6 illustrates a deposit account flowchart, according to some embodiments. As shown the system can determine if the user is a member by checking core system integration and create an application, determine pre-bureau eligibility, and generate and update offers. Core system integration can determine and update notes with payment details from an electronic acceptance, deposit module. Documents can be signed, and an API integration are also included.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A system for providing credit offers, private label prequalification for lenders, and account opening, the system comprising:
at least one user computing device in operable connection with a user network;
an application server in operable communication with the user network, the application server configured to host an application program for providing credit offers, private label prequalification for one or more lenders, and an account opening process, the application program having a user interface module for providing access to the application program via the at least one user computing device;
a processor and a non-transitory, computer readable memory storing instructions that, when executed by the processor upon a user selection, cause the device to:
provide end-to-end account opening; and
provide the deployment of a lending journey.

2. The system of claim 1, wherein the account opening process includes a designation display for a lowest payment, a lowest rate, or an offer.

3. The system of claim 1, wherein the lending journey is not provided with a request for a specific loan amount.

4. The system of claim 1, further comprising a prescreen process to prepare a preapproval file.

5. The system of claim 4, wherein the preapproval file is transmitted via email using a communication module.

6. The system of claim 5, wherein the communication module transmits mail to one or more prequalified buyers.

7. The system of claim 6, further comprising the step of a credit module applying one or more credit rules to the preapproval file.

8. The system of claim 7, further comprising a decision module in communication with at least one credit bureau to determine if the credit bureau may issue the loan to the one or more prequalified buyers.

9. The system of claim 8, wherein a borrower, the credit bureau, a bank, and a credit union can interact with the loan to begin an underwriting process.

10. The system of claim 9, further comprising a deposit account capable of determining if a user is a member by referencing a core system integration, create an application, determine eligibility, and generate one or more update offers.

11. A system for providing credit offers, private label prequalification for lenders, and account opening, the system comprising:
at least one user computing device in operable connection with a user network;
an application server in operable communication with the user network, the application server configured to host an application program for providing credit offers, private label prequalification for one or more lenders, and an account opening process, the application program having a user interface module for providing access to the application program via the at least one user computing device;
a processor and a non-transitory, computer readable memory storing instructions that, when executed by the processor upon a user selection, cause the device to:
providing end-to-end account opening;
determining if a co-borrow is provided;
determining if the user is prequalified;
presenting an offer;
determining if collateral exists, and if collateral does exist, inputting collateral information;
providing approval for a hard inquiry to the borrower's credit report;
determining if the user is auto approved or request additional information.

12. The system of claim 11, wherein the account opening process includes a designation display for a lowest payment, a lowest rate, or an offer.

13. The system of claim 12, wherein the lending journey is not provided with a request for a specific loan amount.

14. The system of claim 13, further comprising a prescreen process to prepare a preapproval file.

15. The system of claim 14, wherein the preapproval file is transmitted via email using a communication module.

16. The system of claim 15, wherein the communication module transmits mail to one or more prequalified buyers.

17. The system of claim 16, further comprising the step of a credit module applying one or more credit rules to the preapproval file.

18. The system of claim 17, further comprising a decision module in communication with at least one credit bureau to determine if the credit bureau may issue the loan to the one or more prequalified buyers.

19. The system of claim 18, wherein a borrower, the credit bureau, a bank, and a credit union can interact with the loan to begin an underwriting process.

20. A method for providing credit offers, private label prequalification for lenders, and account opening, including a processor and a non-transitory, computer readable memory storing instructions that, when executed by the processor upon a user selection, perform the steps of:
providing end-to-end account opening;
determining if a co-borrow is provided;
determining if the user is prequalified;
presenting an offer;
determining if collateral exists, and if collateral does exist, inputting collateral information;
providing approval for a hard inquiry to the borrower's credit report; and
determining if the user is auto approved or request additional information.
